(19) United States
(12) Patent Application Publication
(10) Pub. No.: US 2019/0141031 A1
(43) Pub. Date: May 9, 2019

(54) AUTHENTICATING A USER TO A CLOUD SERVICE AUTOMATICALLY THROUGH A VIRTUAL ASSISTANT

(71) Applicant: INTERNATIONAL BUSINESS MACHINES CORPORATION, ARMONK, NY (US)

(72) Inventors: Bharat Devdas, Bangalore (IN); SRIHARI KULKARNI, Bangalore (IN); Norton Samuel Augustus Stanley, Bangalore (IN)

(21) Appl. No.: 15/808,130

(22) Filed: Nov. 9, 2017

(51) Int. Cl. H04L 29/06; G06F 17/30

(52) U.S. Cl. CPC H04L 63/0861; G06F 17/30864; H04L 63/083

(57) ABSTRACT

According to one embodiment, a method, computer system, and computer program product for identifying and authenticating users of a voice-based virtual assistant is provided. The present invention may include receiving a voice request from a virtual assistant program; identifying a user responsible for issuing the voice request; instructing the virtual assistant program to send a token to the identified user's mobile device, along with one or more instructions that the token be modulated into one or more near-field communications formats and broadcast; receiving a broadcast token; and if the sent token and the broadcast token match, returning one or more sensitive data elements pertaining to the voice request to the virtual assistant program.

### BACKGROUND

The present invention relates, generally, to the field of computing, and more particularly to digital security.

Digital security is the field concerned with protecting an online user's internet account and files from intrusion by an unauthorized entity. Digital security encompasses a broad range of tools and methods for protecting the privacy of a user's data, including firewalls, antivirus and antispyware programs, biometric identification, and data encryption. However, the advent of a new category of consumer devices called virtual assistants has introduced new challenges to the field of digital security; virtual assistants are software agents, sometimes embedded within dedicated hardware platforms, which in their latest incarnations contain little to no visual or physical user interface but interact with users purely through audible speech. This raises new implications for the field of digital security, as maintaining a secure user experience with such voice-based virtual assistants requires that a virtual assistant be capable of distinguishing between different users with a high degree of certainty, such that an unauthorized user can be prevented from accessing private information or giving unauthorized commands.

### SUMMARY

According to one embodiment, a method, computer system, and computer program product for identifying and authenticating users of a voice-based virtual assistant is provided. The present invention may include receiving a voice request from a virtual assistant program; identifying a user responsible for issuing the voice request; instructing the virtual assistant program to send a token to the identified user's mobile device, along with one or more instructions that the token be modulated into one or more near-field communications formats and broadcast; receiving a broadcast token; and, if the sent token and the broadcast token match, returning one or more sensitive data elements pertaining to the voice request to the virtual assistant program.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a voice authentication process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to digital security. The following described exemplary embodiments provide a system, method, and program product to, among other things, identify a user invoking a virtual assistant with a voice command, and authenticate the identified user by sending a digital token to the identified user's mobile device, which is rebroadcast to the virtual assistant via a near-field communication format. Furthermore, the location of the user in relation to the virtual assistant is identified to ensure that the voice command and the audibly broadcast digital token originate from the same location. Therefore, the present embodiment has the capacity to improve the technical field of digital security by reliably authenticating a user of a voice-based virtual assistant with no additional effort required from a user. A user may not be required to memorize and vocalize easily intercepted passwords or security questions, nor does required to interact with a mobile device, thereby increasing user convenience and security.

As previously described, digital security is the field concerned with protecting an online user's internet account and files from intrusion by an unauthorized entity. Digital security encompasses a broad range of tools and methods for protecting the privacy of a user's data, including firewalls, antivirus and antispyware programs, biometric identification, and data encryption. However, the advent of a new category of consumer devices called virtual assistants has introduced new challenges to the field of digital security; virtual assistants are software agents, sometimes embedded within dedicated hardware platforms, which in their latest incarnations contain little to no visual or physical user interface but interact with users purely through audible speech. This raises new implications for the field of digital security, as maintaining a secure user experience with virtual assistants requires that a virtual assistant be capable of distinguishing between different users with a high degree of certainty, such that an unauthorized user can be prevented from accessing private information or giving unauthorized commands.

Virtual assistants are excellent for providing public information, such as weather forecasts, traffic conditions, news stories, et cetera. However, due to the digital security issues attendant with voice interaction, namely the difficulty with confidently identifying a user, virtual assistants cannot be safely used to query sensitive or confidential information, such as “what does my blood report from the lab say?” Additionally, virtual assistants cannot provide personalized answers where more than one person uses the device. For example, in the case of a couple residing in a house equipped with a virtual assistant, a question such as “is my calendar free at 12 PM?” would require identifying the person asking the question. Solutions to the issue have been sought in the field, but all have significant drawbacks that prevent widespread deployment. Voice biometrics are one such example; voice biometrics involve identifying a user by the user's voice. This technology, however, is in its nascent stages and is both error prone, and easily deceived with the aid of high quality microphones and speakers. Shared passwords and security questions unique to each user have also been used as a means of identification with virtual assistants. However, shared passwords and security questions are difficult to memorize, add an additional step to the user-virtual assistant interaction, and most saliently, can be easily overheard by those within earshot of the user. Another method involves the use of a one-time password to the user's personal device, which the user reads aloud to the virtual assistant. While this method overcomes the danger of interception inherent with long-term passwords and security questions, it defeats the purpose of voice interaction with a virtual assistant by forcing the user to access another device, such as a mobile phone or tablet. As such, it may be advantageous to, among other things, implement a system that automatically identifies and authenticates a user of a voice-based virtual assistant by means of location-tracking and ultrasound digital token transmission, such that the user need not remember or vocalize passwords or security questions, engage in an additional authentication step, nor interact with another device.

According to one embodiment, the invention is a method of identifying and authenticating a user of a voice-based virtual assistant by, upon invocation by a user's voice command, uses multiple communication technologies available to consumer devices to identify the user, reliably locate the exact position of the user, and send a digital token to the identified user's mobile device, which is broadcast back to the virtual assistant in a near-field communication format. The virtual assistant then ensures that the geographical location of the broadcast token matches the location of the user who issued the voice command, and that the token broadcast back to the virtual assistant matches the token that was sent out, in which case the user is identified and authenticated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify a user invoking a virtual assistant with a voice command, and authenticate the identified user by sending a digital token to the identified user's mobile device, which is rebroadcast to the virtual assistant via a near-field communication format.

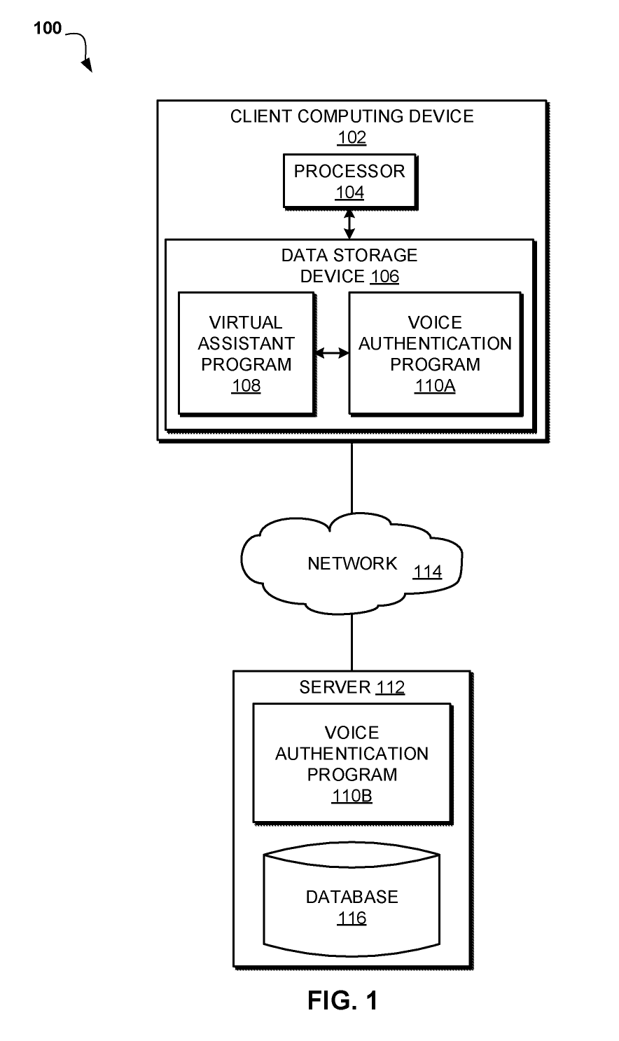

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

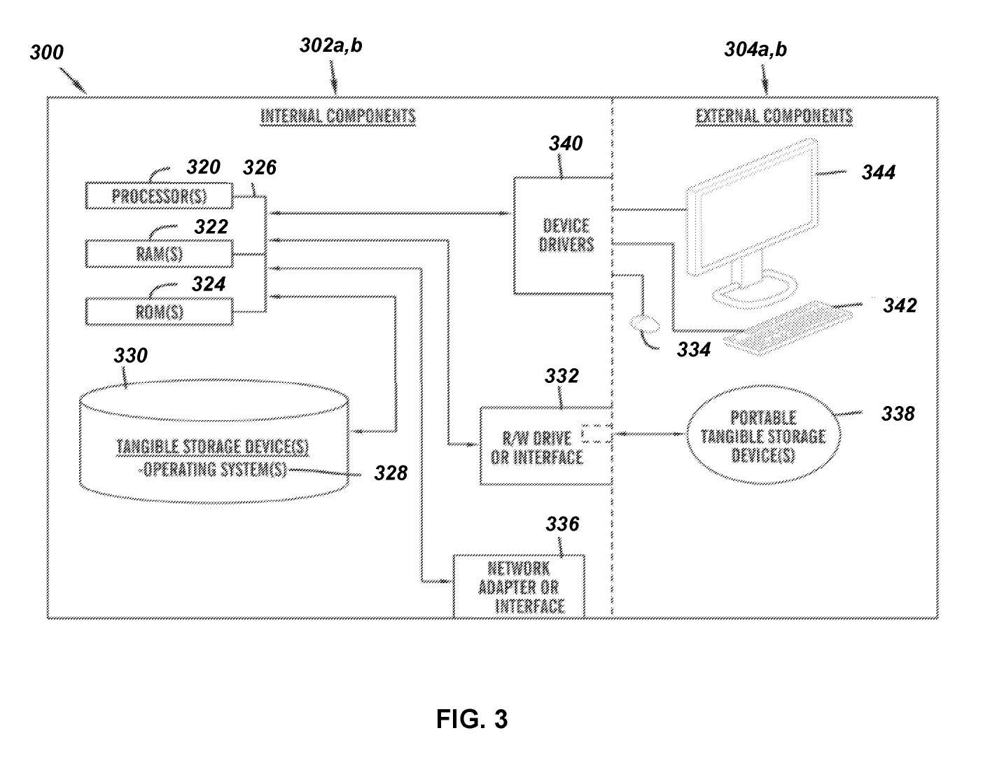

Client computing device 102 may include a processor 104 and a data storage device 106 that is enabled to host and run a virtual assistant program 108 and a voice authentication program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, a smartwatch, a smart speaker, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a voice authentication program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, virtual assistant program 108 may be one of any number of software agents capable of interacting with a user by means of audible speech and providing information or performing tasks based on the voice commands of the user. Examples may include recent commercially successful voice-based virtual assistants, such as Google Home® (Google Home® and all Google Home®-based trademarks and logos are trademarks or registered trademarks of Google Inc. and/or its affiliates), Amazon Echo® (Amazon Echo® and all Amazon Echo®-based trademarks and logos are trademarks or registered trademarks of Amazon Technologies, Inc. and/or its affiliates), and Ski® (Ski® and all Siri®-based trademarks and logos are trademarks or registered trademarks of Apple Inc. and/or its affiliates). Virtual assistant program 108 need not necessarily be located on client computing device 102; virtual assistant program 108 may be located anywhere within communication of the voice authentication program 110A, 110B, such as on server 112 or on any other device located within network 114. Furthermore, virtual assistant program 108 may be distributed in its operation over multiple devices, such as client computing device 102 and server 112. In an alternate embodiment, virtual assistant program 108 may be an app or program distinct from but in communication with a voice-based virtual assistant.

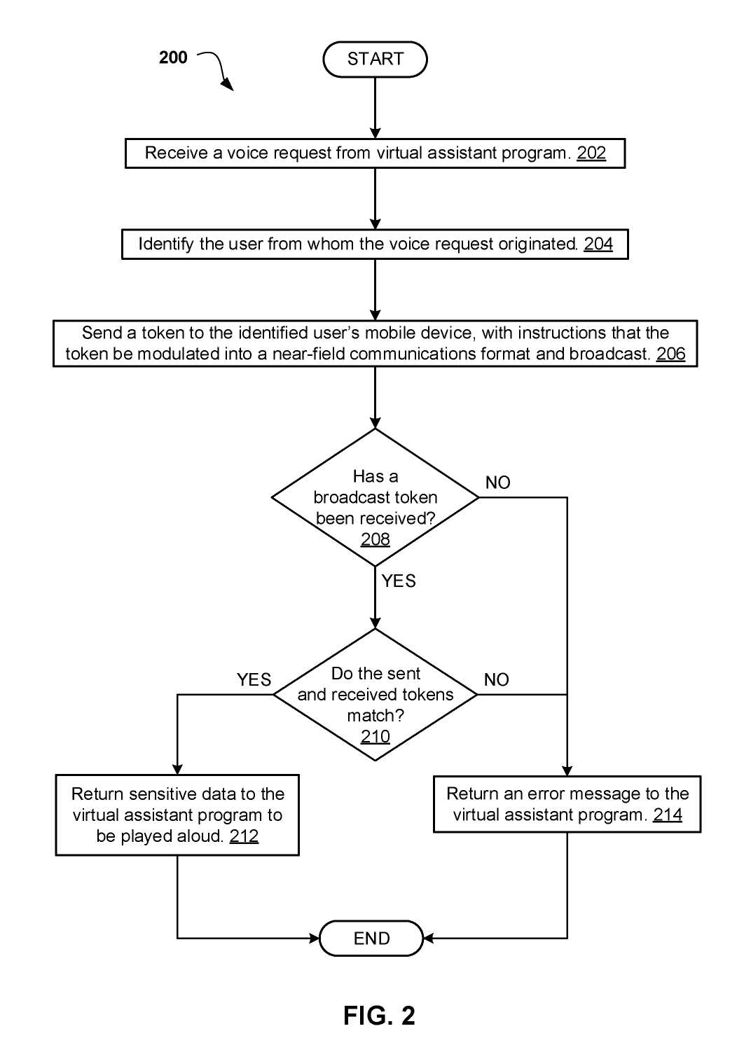

According to the present embodiment, the voice authentication program 110A, 110B may be a program enabled to identify a user invoking a virtual assistant with a voice command, and authenticate the identified user by sending a digital token to the identified user's mobile device, which is rebroadcast to the virtual assistant via a near-field communication format. The voice authentication method is explained in further detail below with respect to FIG. 2. The voice authentication program 110A, 110B may be a discrete program or it may be a subroutine or method integrated into virtual assistant program 108. The voice authentication program 110A, 110B may be located on client computing device 102 or server 112 or on any other device located within network 114. Furthermore, voice authentication program 110A, 110B may be distributed in its operation over multiple devices, such as client computing device 102 and server 112.

Referring now to FIG. 2, an operational flowchart illustrating a voice authentication process 200 is depicted according to at least one embodiment. At 202, the voice authentication program 110A, 110B receives a voice request from a virtual assistant program 108. The voice request may be any spoken request originally communicated by a user to virtual assistant program 108 which virtual assistant program 108 has determined to merit a response containing sensitive data. The user may be any individual who issues a voice request to virtual assistant program 108 and is carrying a mobile computing device, such as a cellular phone, tablet, or smartwatch, on their person. In some embodiments, the user may have an app or program installed on their mobile device to facilitate communication between the mobile device and virtual assistant program 108 or voice authentication program 110A, 110B. The user may further be registered within a database of users accessible to virtual assistant program 108 or voice authentication program 110A, 110B. Sensitive data may be any data that pertains to a user which that user desires to keep private, such as medical records, calendar appointments, financial information, et cetera. The voice request may be communicated from virtual assistant 108 to voice authentication program 110A, 110B in its original audio format or in a textual format. In an alternate embodiment, virtual assistant program 108 may additionally or solely communicate to voice authentication program 110A, 110B an initialization command in this step, where the initialization step causes voice authentication program 110A, 110B to start up and/or to run voice authentication process 200.

Next, at 204, voice authentication program 110A, 110B identifies the user from whom the voice request originated. The voice authentication program 110A, 110B may use a combination of methods, such as voice recognition, passphrases, or security questions to initially identify the user. In an alternate embodiment, voice authentication program 110A, 110B may use acoustic source tracking techniques, such as acoustic source location using a microphone array, to identify the location of a user; voice authentication program 110A, 110B may then broadcast or cause to be broadcast a code to the mobile devices of all users within range of the microphone that received the voice request, with instructions that the code be rebroadcast from the mobile device in a near-field communications format along with the identity of the user. The near-field communications format may include any means of short-range communication available to a consumer device, including ultrasound, Wi-Fi, Bluetooth® (Bluetooth® and all Bluetooth®-based trademarks and logos are trademarks or registered trademarks of The Bluetooth Special Interest Group and/or its affiliates), et cetera. The voice authentication program 110A, 110B may then use source tracking techniques, such as a Wi-Fi positioning system, acoustic source tracking, signal intensity tracking, et cetera, to locate the source of the rebroadcast code, and may then check to ensure that the source of the initial voice request is the same location as the source of the rebroadcast code. If the locations match, then the voice authentication program 110A, 110B may associate the user at that location with the user identity broadcast from that user's mobile device along with the code.

Then, at 206, voice authentication program 110A, 110B sends a token to the identified user's mobile device, with instructions that the token be modulated into a near-field communications format and broadcast. The token may be any digital key, which may be encrypted, and may be a persistent key unique to each user or a one-time use key generated anew each time voice authentication program 110A, 110B executes this step. In an alternate embodiment, voice authentication program 110A, 110B may send the token and the instructions to the virtual assistant program 108 to be broadcast to the identified user's mobile device. In some embodiments, the instructions may be omitted, particularly where the user's mobile device contains an app or program designed to interoperate with virtual assistant program 108 or voice authentication program 110A, 110B and is pre-programmed to modulate a received token into a near-field communications format and broadcast it without requiring express instruction from virtual assistant program 108 or voice authentication program 110A, 110B to do so. The token and/or instructions may be broadcast from the mobile device any number of times; redundant broadcasts may be desirable to ensure receipt of the transmission.

Next, at 208, voice authentication program 110A, 110B determines whether a broadcast token has been received. The voice authentication program 110A, 110B may make this determination any number of ways, such as by checking storage space allocated to itself for the presence of the received token, or by checking activity logs to see if a file was received. According to one implementation, if the voice authentication program 110A, 110B determines that a broadcast token has been received (step 208, “YES” branch), the voice authentication program 110A, 110B may continue to step 210 to further determine if the received token matches the sent token. If the voice authentication program 110A, 110B determines that a broadcast token has not been received (step 208, “NO” branch), the voice authentication program 110A, 110B may move to step 214 to return an error message to the virtual assistant program. The voice authentication program 110A, 110B may wait for any amount of time to make this determination, and may execute this step multiple times in the course of performing the method until a broadcast token has been received. The broadcast token may be received by voice authentication program 110A, 110B from virtual assistant program 108, may be received from sensors in communication with voice authentication program 110A, 110B, or may be received from any other entity in communication with voice authentication program 110A, 110B, such as a sensor manager, Wi-Fi router, Bluetooth® utility, et cetera.

Then, at 210, voice authentication program 110A, 110B determines whether the sent and received tokens match. The voice authentication program 110A, 110B makes this determination by simply checking to ensure that the sent and received tokens are identical to each other. According to one implementation, if the voice authentication program 110A, 110B determines that the sent token and received token match (step 210, “YES” branch), the voice authentication program 110A, 110B may continue to step 212 to return sensitive data to the virtual assistant program to be played aloud. If the voice authentication program 110A, 110B determines that the sent token and received token do not match (step 210, “NO” branch), the voice authentication program 110A, 110B may move to step 214 to return an error message to the virtual assistant program.

Then, at 212, voice authentication program 110A, 110B returns sensitive data to the virtual assistant program 108 to be played aloud. The voice authentication program 110A, 110B may access the sensitive data by identifying the type and location of the data through contextual analysis of the voice command received in step 202 from the virtual assistant program 108. The voice authentication program 110A, 110B may also instruct virtual assistant program 108 or an independent natural language processing utility to process the voice request and identify the type and location of the data. Alternately, voice authentication program 110A, 110B may receive the type and/or location of the data from virtual assistant process 108. The voice authentication program 110A, 110B may then retrieve the sensitive data from the identified location and pass it to virtual assistant program 108 to be returned to the user. In an alternate embodiment, voice authentication program 110A, 110B may pass the authenticated status of the user to virtual assistant program 108, and virtual assistant program 108 may use this authenticated status to access the sensitive data itself and communicate the sensitive data to the user. In such embodiments, step 212 may be omitted. After this step, voice authentication program 110A, 110B may terminate.

Alternately, at 214, voice authentication program 110A, 110B returns an error message to the virtual assistant program 108. The error message may be any message that conveys the status of or events affecting voice authentication program 110A, 110B to virtual assistant program 108. For example, if a broadcast token has not been received, the error message may be a message communicating the absence of the broadcast token. In the event that the sent and received tokens do not match, the error message may convey the failure of the tokens to match to virtual assistant program 108. The error messages may contain standard error codes such as a 403 forbidden response or an HTTP 401 error code.

It may be appreciated that FIG. 2 provides only an illustration of one implementation and does not imply any limitations with regard to how different embodiments may be implemented. Many modifications to the depicted environments may be made based on design and implementation requirements. For instance, in one embodiment, voice authentication program 110A, 110B may alert virtual assistant program 108 to the presence of additional users, or the presence of unauthorized users, within a threshold distance of the speakers connected with virtual assistant program 108, and may prevent virtual assistant program 108 from communicating sensitive data until there are no additional users or no unauthorized users present. The threshold distance may be pre-programmed by a user or may be automatically determined by voice authentication program 110A, 110B or virtual assistant program 108, and may be based on the distance at which the speakers connected with virtual assistant program 108 can be heard by a user, may be based on the distance at which the sensor or sensors connected with virtual assistant program 108 can detect an audible command or a communication transmitted in a near-field communication format. In an alternate embodiment, voice authentication program 110A, 110B may not deal with sensitive data, but may instead serve to identify and/or authenticate users in order to communicate the identity of proximate users and/or authenticated users to virtual assistant program 108, enabling virtual assistant program 108 to personalize its interactions based on the identity of individual users.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the virtual assistant program 108 and the voice authentication program 110A in the client computing device 102, and the voice authentication program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the voice authentication program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The virtual assistant program 108 and the voice authentication program 110A in the client computing device 102 and the voice authentication program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the virtual assistant program 108 and the voice authentication program 110A in the client computing device 102 and the voice authentication program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

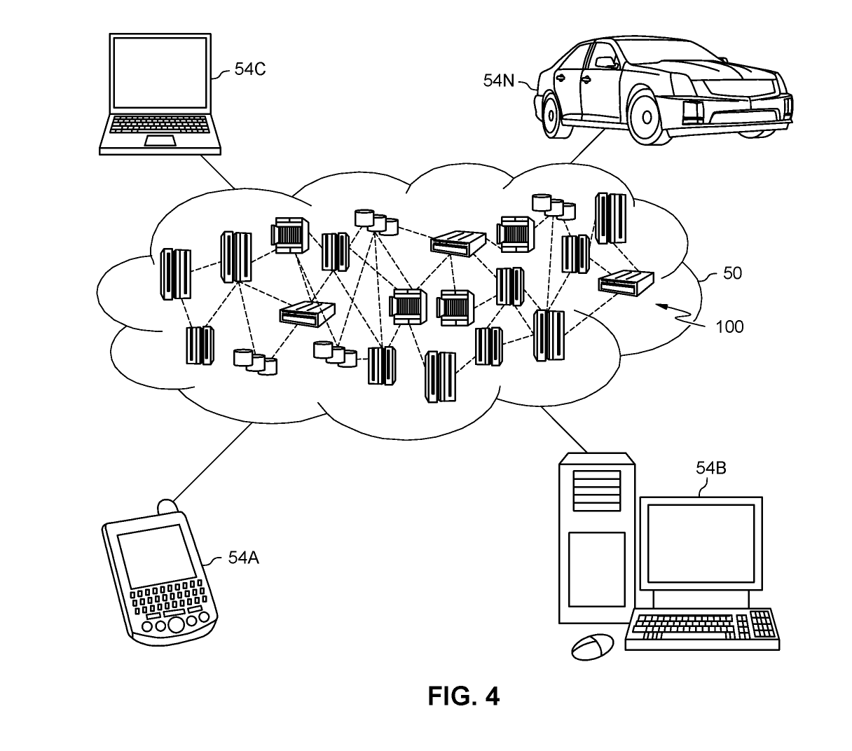

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

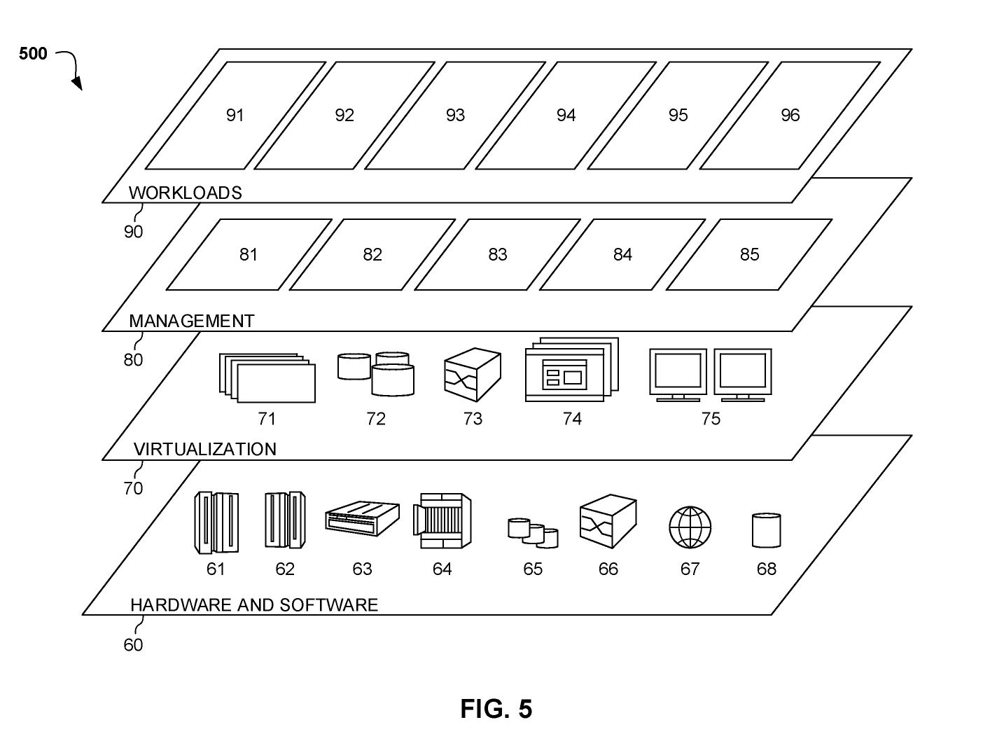

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and voice authentication 96. Voice authentication 96 may relate to identifying a user invoking a virtual assistant with a voice command, and authenticating the identified user by sending a digital token to the identified user's mobile device, which is rebroadcast to the virtual assistant via a near-field communication format.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for authenticating a user of a voice-based virtual assistant, the method comprising:
receiving a voice request from a virtual assistant program;
identifying a user responsible for issuing the received voice request;
instructing the virtual assistant program to send a token to one or more mobile devices associated with the identified user, along with one or more instructions that the token be modulated into one or more near-field communications formats and transmitted to the virtual assistant program;
receiving a transmitted token; and
if the sent token and the broadcast token match, transmitting one or more sensitive data elements pertaining to the voice request to the virtual assistant program.

2. The method of claim 1, wherein a user responsible for issuing the voice request is identified using one or more methods selected from a group consisting of voice recognition, a password, a passphrase, and a security question.

3. The method of claim 1, wherein identifying a user responsible for issuing the voice request further comprises:
locating an origin of the voice request using one or more acoustic source tracking techniques;
instructing the virtual assistant program to broadcast one or more codes to the one or more mobile devices of one or more nearby users, along with instructions that a code of the one or more codes and an identity of a user of each mobile device be broadcast from the one or more mobile devices in a near-field communications format;
locating one or more sources of the one or more broadcast codes using one or more source tracking techniques; and
if the origin of the voice request matches any of the one or more sources of the one or more broadcast codes, assigning a broadcast identity associated with the matched code to the origin of the voice request to identify the user.

4. The method of claim 1, further comprising:
identifying all users within a threshold distance of the virtual assistant; and
communicating a number of identified users to the virtual assistant.

5. The method of claim 1, wherein the type and location of the one or more sensitive data elements are identified using contextual analysis of the voice request.

6. The method of claim 1, wherein an identity of the user is registered within one or more data repositories accessible to the virtual assistant.

7. The method of claim 1, wherein the one or more mobile devices contain one or more apps that facilitate communication between the one or more mobile devices and the virtual assistant.

8. A computer system for authenticating a user of a voice-based virtual assistant, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a voice request from a virtual assistant program;
identifying a user responsible for issuing the received voice request;
instructing the virtual assistant program to send a token to one or more mobile devices associated with the identified user, along with one or more instructions that the token be modulated into one or more near-field communications formats and transmitted to the virtual assistant program;
receiving a transmitted token; and
if the sent token and the broadcast token match, transmitting one or more sensitive data elements pertaining to the voice request to the virtual assistant program.

9. The computer system of claim 8, wherein a user responsible for issuing the voice request is identified using one or more methods selected from a group consisting of voice recognition, a password, a passphrase, and a security question.

10. The computer system of claim 8, wherein identifying a user responsible for issuing the voice request further comprises:
locating an origin of the voice request using one or more acoustic source tracking techniques;
instructing the virtual assistant program to broadcast one or more codes to the one or more mobile devices of one or more nearby users, along with instructions that a code of the one or more codes and an identity of a user of each mobile device be broadcast from the one or more mobile devices in a near-field communications format;
locating one or more sources of the one or more broadcast codes using one or more source tracking techniques; and
if the origin of the voice request matches any of the one or more sources of the one or more broadcast codes, assigning the broadcast identity associated with the matched code to the origin of the voice request to identify the user.

11. The computer system of claim 8, further comprising:
identifying all users within a threshold distance of the virtual assistant; and
communicating a number of identified users to the virtual assistant.

12. The computer system of claim 8, wherein the type and location of the one or more sensitive data elements are identified using contextual analysis of the voice request.

13. The computer system of claim 8, wherein an identity of the user is registered within one or more data repositories accessible to the virtual assistant.

14. The computer system of claim 8, wherein the one or more mobile devices contain one or more apps that facilitate communication between the one or more mobile devices and the virtual assistant.

15. A computer program product for authenticating a user of a voice-based virtual assistant, the computer program product comprising:
one or more computer-readable tangible storage medium and program instructions stored on at least one of the one or more tangible storage medium, the program instructions executable by a processor to cause the processor to perform a method comprising:
receiving a voice request from a virtual assistant program;
identifying a user responsible for issuing the received voice request;
instructing the virtual assistant program to send a token to one or more mobile devices associated with the identified user, along with one or more instructions that the token be modulated into one or more near-field communications formats and transmitted to the virtual assistant program;
receiving a transmitted token; and
if the sent token and the broadcast token match, transmitting one or more sensitive data elements pertaining to the voice request to the virtual assistant program.

16. The computer program product of claim 15, wherein a user responsible for issuing the voice request is identified using one or more methods selected from a group consisting of voice recognition, a password, a passphrase, and a security question.

17. The computer program product of claim 15, wherein identifying a user responsible for issuing the voice request further comprises:
locating an origin of the voice request using one or more acoustic source tracking techniques;
instructing the virtual assistant program to broadcast one or more codes to the one or more mobile devices of one or more nearby users, along with instructions that a code of the one or more codes and an identity of a user of each mobile device be broadcast from the one or more mobile devices in a near-field communications format;
locating one or more sources of the one or more broadcast codes using one or more source tracking techniques; and
if the origin of the voice request matches any of the one or more sources of the one or more broadcast codes, assigning the broadcast identity associated with the matched code to the origin of the voice request to identify the user.

18. The computer program product of claim 15, further comprising:
identifying all users within a threshold distance of the virtual assistant; and
communicating a number of identified users to the virtual assistant.

19. The computer program product of claim 15, wherein the type and location of the one or more sensitive data elements are identified using contextual analysis of the voice request.

20. The computer program product of claim 15, wherein an identity of the user is registered within one or more data repositories accessible to the virtual assistant.
